(19) United States
(12) Patent Application Publication
(10) Pub. No.: US 2021/0237635 A1
(43) Pub. Date: Aug. 5, 2021

(54) Car Mat Structures

(71) Applicant: FORMOSA SAINT JOSE CORPORATION, Taipei (TW)

(72) Inventor: Ming-Shun Yang, Taipei (TW)

(73) Assignee: FORMOSA SAINT JOSE CORP., Taipei (TW)

(21) Appl. No.: 16/843,230

(22) Filed: Apr. 8, 2020

(30) Foreign Application Priority Data
Feb. 4, 2020 (TW) 109103295

(51) Int. Cl. B60N 3/04

(52) U.S. Cl. CPC B60N 3/048; B60N 3/044

(57) ABSTRACT

The present invention discloses car mat structures used to set on the floor compartment area in a car to contain water drops or debris fallen or brought into the car. One car mat structure includes a bottom pad with plural sidelines; and plural dams, each being raised from one said sideline, wherein two opposite members of the dams are dual slop walls each being built with two inclined surfaces with different inclined angles. Another car mat structure includes a bottom pad; plural dams raised from the sidelines of the bottom pad; and plural triangle shutters formed to cover bottom corners each formed by two adjacent dams and the bottom pad. A third car mat structure includes a bottom pad; plural dams raised from the sidelines of the bottom pad, wherein two opposite members of the dams each being built with two inclined surfaces with different inclined angles; and plural triangle shutters. With the implementation of the new design dams and triangle shutters of the present invention, molding is easier when forming and producing mat structures; cleaning becomes easier since no hidden corners existing on the mat structures; and deformation or collapsing of mat structures being effectively prevented. When further build an inclined cover pad to cover the junction area between a dam and the bottom pad, molding for production and cleaning the mats become even more convenient and efficient.

### BACKGROUND OF THE INVENTION

### 1. Technical Field

The present invention relates to mat structures, and more particularly, to car mat structures for car applications.

### 2. Description of Related Art

Being important and necessary equipment on a car, car mats are widely used nowadays. Car users normally have more than one set of car mats for different environment conditions. When set on the foot resting area inside a car, car mats are used to be a buffer, or more importantly, used to contain water drops or debris fallen into the car chamber.

However, every known existing car mat in the market or being used is basically a plastic product with a nearly 90 degree angle connection from its side wall to its bottom surface that inevitably leave a crevice or gap in between the side wall and the foot resting area in the car chamber applying the car mat.

What can be worse is that the side wall of the mat suffers deformation or even collapsing inwardly after being used for a period of time, not only causing tremendous trouble or inconvenience, but also greatly affect driving and put the driver, the passenger, and even the passersby or other cars on the road in great and unpredictable danger.

Moreover, due to the almost 90 degree connection of the wall with the bottom surface of the mat, deformation in the connection part and in the bottom angle portion formed by 2 connecting walls with the bottom surface is generally severe, and cleaning of them becomes even more difficult.

That results in the needs and innovative breakthrough for the creative invention of car mat structures with dual slop walls that not only being easy to produce or apply with increasing life time of its usage, but also being able to provide convenience and the more important safety of driving.

### SUMMARY OF THE INVENTION

The present invention discloses car mat structures used to set firmly on the foot resting area of a car to contain water drops or debris fallen or brought into the car. One car mat structure includes a bottom pad with plural sidelines; and plural dams, each being raised from one said sideline, wherein two opposite members of the dams are dual slop walls each being built with two inclined surfaces with different inclined angles. Another car mat structure includes a bottom pad; plural dams raised from the sidelines of the bottom pad; and plural triangle shutters formed to cover bottom corners each formed by two adjacent dams and the bottom pad. A third car mat structure includes a bottom pad; plural dams raised from the sidelines of the bottom pad, wherein two opposite members of the dams each being built with two inclined surfaces with different inclined angles; and plural triangle shutters. With the implementation of the new design dams and triangle shutters of the present invention, molding is easier when forming and producing mat structures; cleaning becomes easier since no hidden corners existing on the mat structures; and deformation or collapsing of mat structures being effectively prevented. When further build an inclined cover pad to cover the junction area between a dam and the bottom pad, molding for production and cleaning the mats become even more convenient and efficient.

The present invention provides a car mat structure, used to set firmly on the foot resting area of a car, the car mat structure comprises: a bottom pad, being formed with plural sidelines; and plural dams, being raised walls each shaped and formed on a sideline, and side-to-side connected to surround the bottom pad, wherein each of two opposite dams having a first inclined surface and a second inclined surface with different inclined angles.

The present invention also provides a car mat structure, used to set firmly on the foot resting area of a car, the car mat structure comprises: a bottom pad, being formed with plural sidelines; plural dams, being raised walls each shaped and formed on a sideline, and side-to-side connected to surround the bottom pad; and plural triangle shutters, each covers and seals one of the plural bottom corners formed by 2 adjacent dams and the bottom pad.

The present invention further provides a car mat structure, used to set firmly on the foot resting area of a car, the car mat structure comprises: a bottom pad, being formed with plural sidelines; plural dams, being raised walls each shaped and formed on a sideline, and side-to-side connected to surround the bottom pad, wherein each of two opposite dams having a first inclined surface and a second inclined surface with different inclined angles; and plural triangle shutters, each covers and seals one of the plural bottom corners formed by 2 adjacent dams and the bottom pad.

Implementation of the present invention at least involves the following inventive steps:

1. Molding is easier when forming and producing mat structures.

2. Cleaning becomes easier since no hidden corners existing on the mat structures.

3. Deformation or collapsing of mat structures being effectively prevented.

4. When further build an inclined cover pad to cover the junction area between a dam and the bottom pad, molding for production and cleaning the mats become even more convenient and efficient.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic three-dimensional diagram of a car mat structure according to an embodiment of the present invention.

FIG. 2 is a schematic three-dimensional diagram of a bottom pad according to an embodiment of the present invention.

FIG. 3 is a schematic cross-sectional view of a car mat structure according to an embodiment of the present invention.

FIG. 4 is a schematic three-dimensional diagram of another car mat structure according to an embodiment of the present invention.

FIG. 5 is a schematic three-dimensional diagram of another bottom pad according to an embodiment of the present invention.

FIG. 6 is a schematic three-dimensional diagram of another car mat structure according to an embodiment of the present invention.

FIG. 7 is a schematic three-dimensional diagram of another bottom pad according to an embodiment of the present invention.

FIG. 8 is a schematic cross-sectional view of another car mat structure according to an embodiment of the present invention.

FIG. 9A is a schematic three-dimensional diagram of an inclined cover pad implemented to cover the junction area between a dam and the bottom pad according to an embodiment of the present invention.

FIG. 9B is a schematic cross-sectional diagram of an inclined cover pad implemented to cover the junction area between a dam and the bottom pad according to an embodiment of the present invention.

FIG. 10A is a schematic three-dimensional diagram of an inclined cover pad implemented to cover the junction area between a dam and the bottom pad according to another embodiment of the present invention.

FIG. 10B is a schematic cross-sectional diagram of an inclined cover pad implemented to cover the junction area between a dam and the bottom pad, and plural triangle shutters formed to cover and seal bottom corners according to an embodiment of the present invention.

FIG. 11A is a schematic three-dimensional diagram of the upper part of two opposite dams being an inverted V shape according to an embodiment of the present invention.

FIG. 11B is a schematic cross-sectional diagram of the upper part of two opposite dams being an inverted V shape according to an embodiment of the present invention.

FIG. 12A is another schematic three-dimensional diagram of the upper part of two opposite dams being an inverted V shape according to an embodiment of the present invention.

FIG. 12B is another schematic cross-sectional diagram of the upper part of two opposite dams being an inverted V shape according to an embodiment of the present invention.

### DETAILED DESCRIPTION OF THE EMBODIMENTS OF THE INVENTION

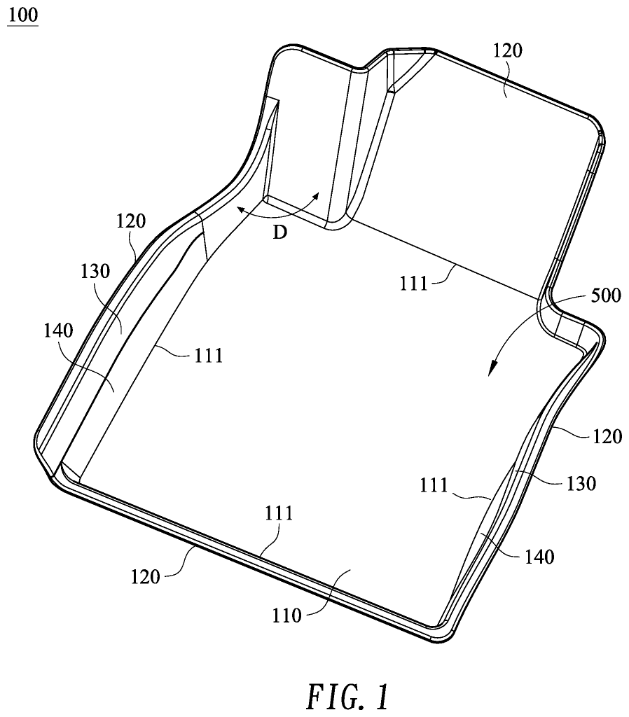

Please refer to FIG. 1, in an embodiment of the present invention, a car mat structure 100, used to set firmly on the foot resting area of a car, includes a bottom pad 110 and plural dams 120.

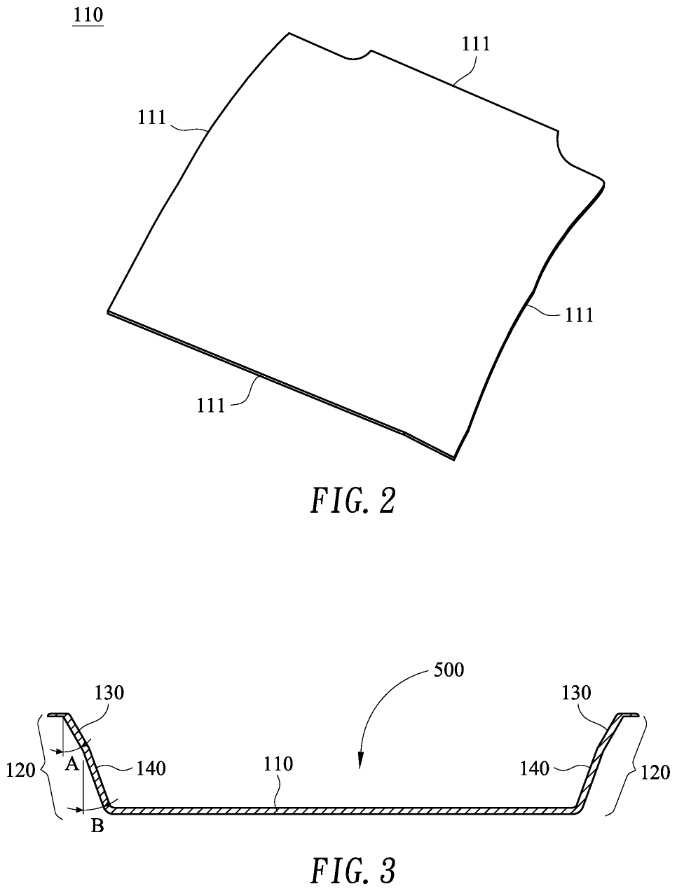

As shown in FIG. 1 and FIG. 2, the bottom pad 110, being formed as a pad with plural sidelines 111, has no restriction in the number of the sidelines 111. However, there can be 4 sidelines 111 on the bottom pad 110, and when the number of the sidelines 111 is 4, the angle D between any two adjacent sidelines is nearly 90 degrees.

The forming material for the bottom pad 110 can be plastic, polymer, or other material that is light, tough, water proof, or easy to be cleaned. While the shape, color or the thickness required are all chosen to meet the application requirements of different car types.

As can be seen in the embodiment shown in FIG. 1 and FIG. 3, plural dams 120, being raised walls each shaped and formed on a sideline 111, side-to-side connecting each other to surround the bottom pad 110 forming a containing area 500 together with the bottom pad to contain water drops or debris fallen into the car chamber.

As also shown in FIG. 1 and FIG. 3, two opposite dams 120 each having a first inclined surface 130 and a second inclined surface 140 with different inclined angles, angle A and angle B, being formed to prevent the dams 120 from suffering deformation or even collapsing inwardly after being used for a period of time and to achieve the effect of intensifying or strengthening the car mat structure 100.

In an embodiment, said two opposite dams 120 can be applied parallel or almost parallel to the front direction of the car, or in other words, said two opposite dams 120 are in both sides of the feet when the driver or the passenger puts his or her feet in the containing area 500 of the car mat structure 100.

Wherein said two opposite dams 120 being almost parallel to the front direction of the car can also refer to an angle of no larger than 10 degrees between the front direction of the car and said two opposite dams 120, and is basically depending upon the shape of the foot resting area of the car.

Please refer also to FIG. 3, for better durability and structural rigidness of the said two opposite dams 120, the angle A between the first inclined surface 130 and a vertical line is larger than the angle B between the second inclined surface 140 and a vertical line.

In other embodiments (not shown in the figures), the first inclined surface 130 together with the second inclined surface 140 can be replaced by a curved surface to strengthen the said two opposite dams 120, deformation or even collapsing can also be prevented.

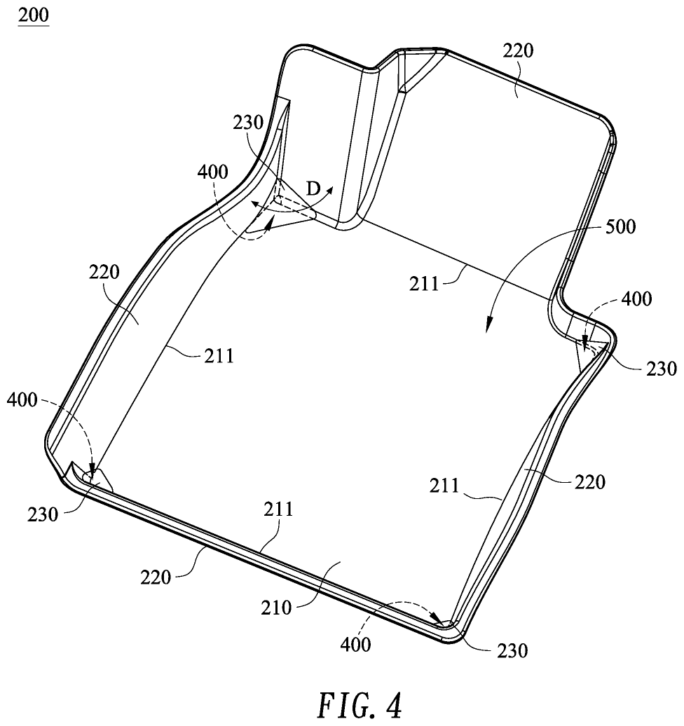

Please refer then to FIG. 4, in another embodiment of the present invention, is a car mat structure 200, used to set firmly on the foot resting area of a car, car mat structure 200 includes a bottom pad 210; plural dams 220; and plural triangle shutters 230.

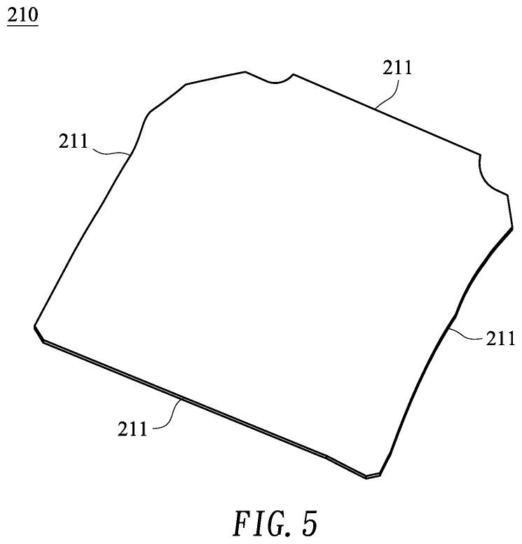

Referring to FIG. 4 and FIG. 5, the bottom pad 210, being formed with plural sidelines 211, has the same characteristic features as the bottom pad 110 and is not to be repeatedly described again.

As shown in FIG. 4, plural dams 220, being raised walls, are formed on the sidelines 211 of the bottom pad 210, and side-to-side connecting each other to surround the bottom pad 210 to form a containing area 500 together with the bottom pad 210 to contain water drops or debris fallen into the car chamber.

As also shown in FIG. 4, plural triangle shutters 230 being formed on the car mat structure 200, each triangle shutter 230 covers and seals one of the plural bottom corners 400 formed by two adjacent dams 220 and the bottom pad 210.

As such, no dirt, debris or water drop will fall into or stay in any of the bottom corners 400, and cleaning the car mat structure 200 is even easier.

On the other hand, in an embodiment, when said bottom pad 210 is quadrilateral, the number of the dams 220 is also 4, and the angle D between any two adjacent dams 220 is nearly 90 degrees or can be 90 degrees±5 degrees.

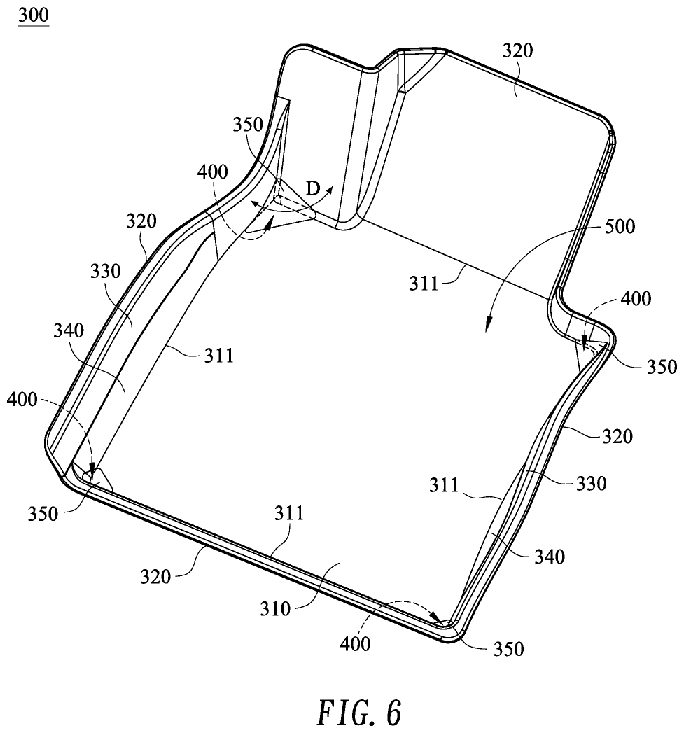

Please refer next to FIG. 6, in an embodiment of the present invention, is another car mat structure 300, used to set firmly on the foot resting area of a car, the car mat structure 300 comprises: a bottom pad 310; plural dams 320; and plural triangle shutters 350.

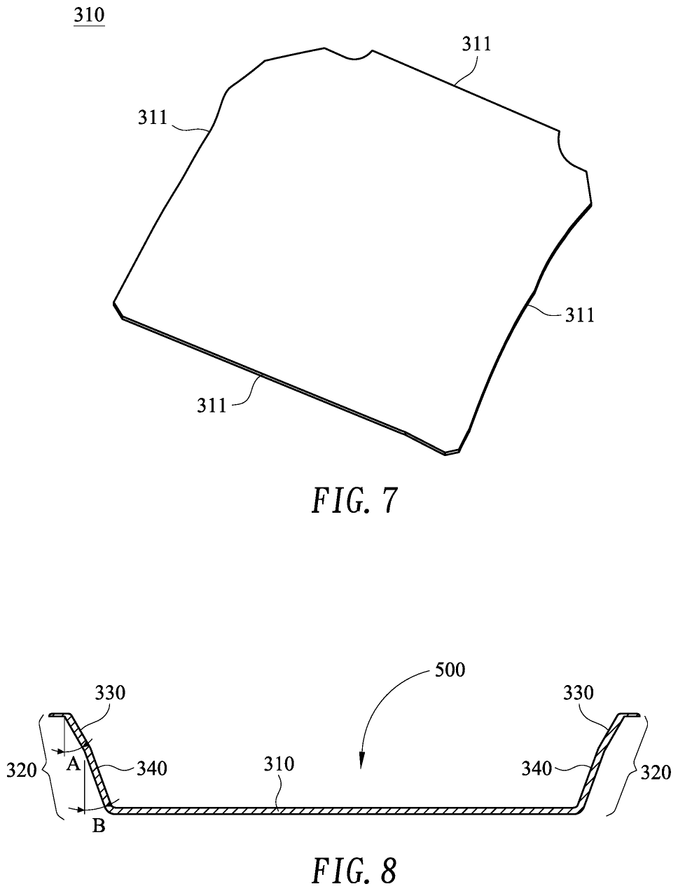

As shown in FIG. 6 and FIG. 7, bottom pad 310, being formed with plural sidelines 311, has the same characteristic features as the above described bottom pad 110, and neither will be repeatedly described.

Referring to FIG. 6 and FIG. 8, plural dams 320, being raised walls, are formed on the sidelines 311 of the bottom pad 310, and side-to-side connecting each other to surround the bottom pad 310 to form a containing area 500 together with the bottom pad 310 to contain water drops or debris fallen into the car chamber.

As shown in FIG. 6 and FIG. 8, two opposite dams 320 each having a first inclined surface 330 and a second inclined surface 340 with different inclined angles, angle A and angle B, being formed to prevent the dams 320 from suffering deformation or even collapsing inwardly after being used for a period of time and to achieve the effect of intensifying or strengthening the car mat structure 300.

Said two opposite dams 320 can be applied parallel or almost parallel to the front direction of the car, or in other words, said two opposite dams 320 are in both sides of the feet when the driver or the passenger puts his or her feet in the containing area 500 of the car mat structure 300

As can be seen in FIG. 8, for better durability and structural rigidness of the said two opposite dams 320, the angle A between the first inclined surface 330 and a vertical line is larger than the angle B between the second inclined surface 340 and a vertical line.

In other embodiments (not shown in the figures), the first inclined surface 330 together with the second inclined surface 340 can also be replaced by a curved surface to also make said two opposite dams 320 stronger that deformation or even collapsing can also be prevented.

Please refer again to FIG. 6, the triangle shutters 350 of the car mat structure 300 in the embodiment are formed to cover and seal plural bottom corners 400 formed by every two adjacent dams 320 and the bottom pad 310 in a manner that each triangle shutter 350 covers and seals one bottom corner 400.

Thus, no dirt, debris or water drop will fall into or stay in any of the bottom corners 400, and cleaning the car mat structure 300 is far easier.

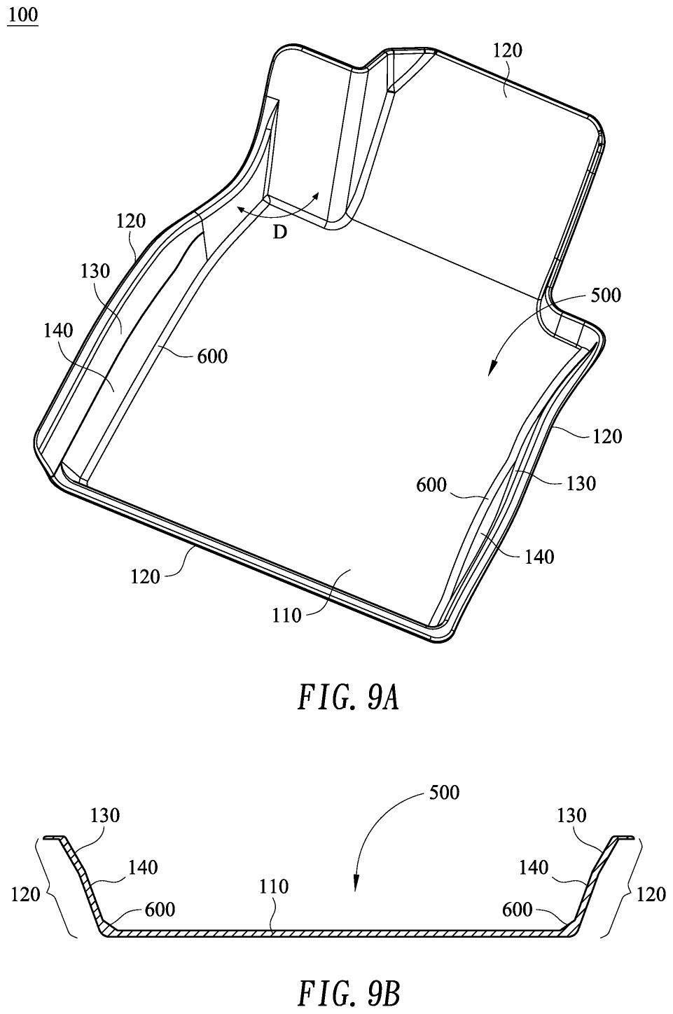

Furthermore, as shown in FIG. 9A and FIG. 9B, inclined cover pads 600 can be further formed and each covers the junction area between any of the two opposite dams 120 with the bottom pad 110, providing efficient molding for production and cleaning the car mat structure 100 becomes even more convenient and easier.

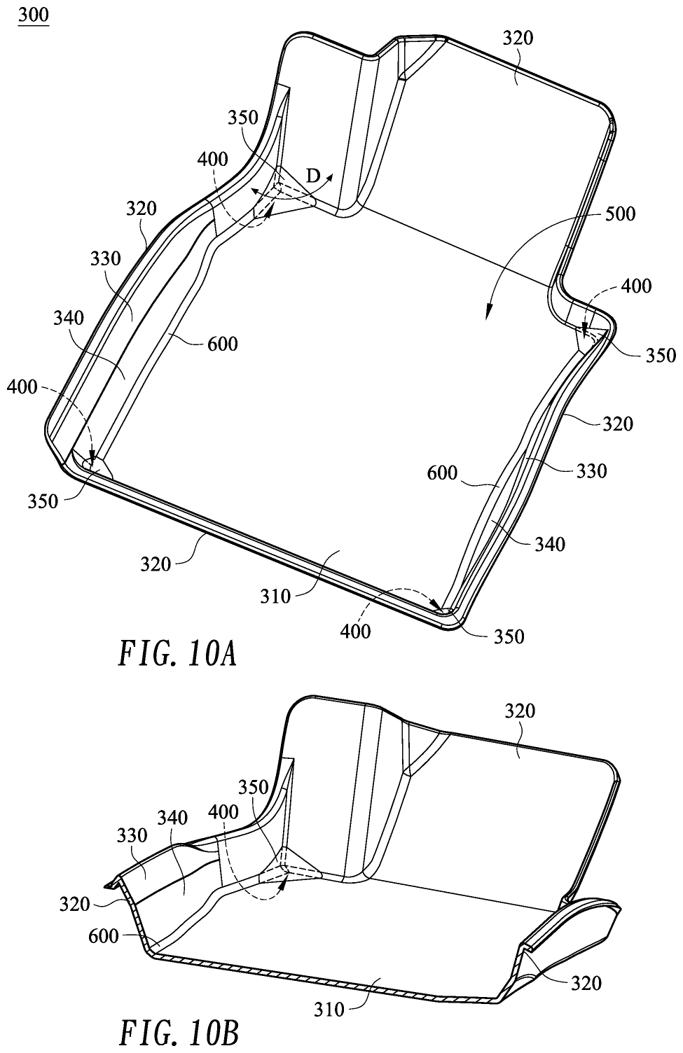

In another embodiment, as shown in FIG. 10A, inclined cover pads 600 can also be formed and each covers the junction area between any of the two opposite dams 320 with the bottom pad 310 to provide efficient molding for production and easier cleaning of the car mat structure 300.

Referring to FIG. 10B, the cross-sectional view of the car mat structure 300 better shows the inward protruding junction of the first inclined surface 330 and the second inclined surface 340 intensifying the structural rigidity and durability of the car mat structure 300, and the ease of cleaning due to the inclined cover pads 600 and the triangle shutters 350.

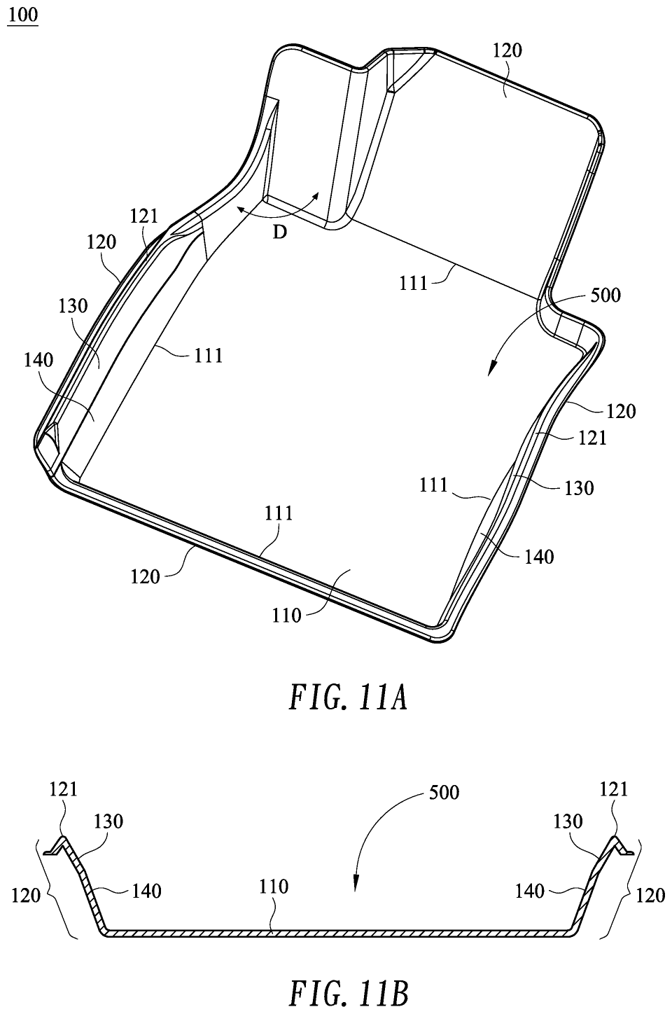

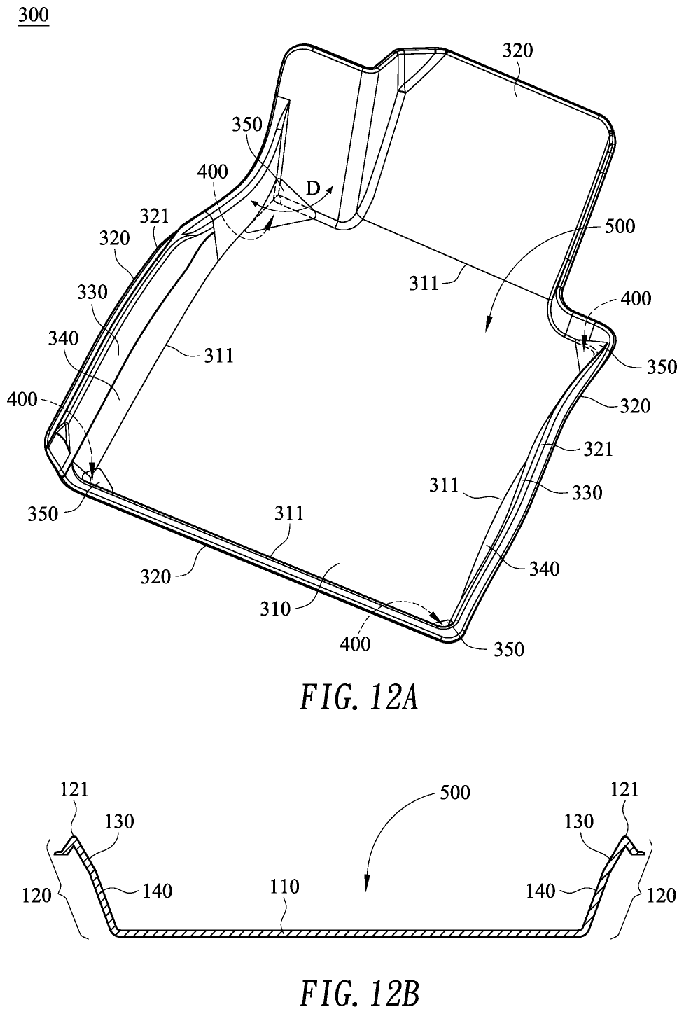

In another aspect, as shown in FIG. 11A, FIG. 11B, FIG. 12A and FIG. 12B, for further enhancement of the structural force of the dams 120 or dams 320, the upper part 121 of each of the said two opposite dams 120 or the upper part 321 of t each of the said two opposite dams 320 can be formed in an inverted V shape.

All in all, as can be seen in FIG. 1 to FIG. 12B and above embodiments, with the implementation of the car mat structure 100, car mat structure 200 or car mat structure 300 of the present invention, molding is easier when forming or in production; deformation or collapsing is effectively prevented; cleaning becomes easier; and when the inclined cover pads 600 are applied, cleaning car mat structure 100 or car mat structure 300 will be far more simple since being without any hidden area.

Last but not least, the structure design of dual slop structure (means the first inclined surface 130 with the second inclined surface 140, or the first inclined surface 330 with the second inclined surface 340) together with the structure design of the triangle shutters (triangle shutters 230 or triangle shutters 350) is not limited to the mat applications in the driving area, but to each and every mats in the foot resting area or cargo containing area in a car. Further, when visual or other application effects are required, structure of pattern or groove can be designed in and produced on the car mat structure 100, car mat structure 200 or car mat structure 300.

The embodiments described above are intended only to demonstrate the technical concept and features of the present invention to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A car mat structure, used to set firmly on the foot resting area of a car, the car mat structure comprises:
a bottom pad, being formed with plural sidelines; and
plural dams, being raised walls each shaped and formed on a sideline, side-to-side connecting to surround the bottom pad to form a containing area together with the bottom pad, wherein each of two opposite dams having a first inclined surface and a second inclined surface with different inclined angles.

2. A car mat structure, used to set firmly on the foot resting area of a car, the car mat structure comprises:
a bottom pad, being formed with plural sidelines;
plural dams, being raised walls each formed on a sideline, are side-to-side connecting each other to surround the bottom pad to form a containing area together with the bottom pad; and
plural triangle shutters, each covers and seals one of the plural bottom corners formed by two adjacent dams and the bottom pad.

3. A car mat structure, used to set firmly on the foot resting area of a car, the car mat structure comprises:
a bottom pad, being formed with plural sidelines;
plural dams, being raised walls each shaped and formed on a sideline, and side-to-side connected to surround the bottom pad, wherein each of two opposite dams having a first inclined surface and a second inclined surface with different inclined angles; and
plural triangle shutters, each covers and seals one of the plural bottom corners formed by two adjacent dams and the bottom pad.

4. The car mat structure according to claim 1, wherein a containing area being formed by said dams together with the bottom pad.

5. The car mat structure according to claim 2, wherein a containing area being formed by said dams together with the bottom pad.

6. The car mat structure according to claim 3, wherein a containing area being formed by said dams together with the bottom pad.

7. The car mat structure according to claim 1, wherein inclined cover pads being further formed and each covers the junction area between any of the two opposite dams with the bottom pad.

8. The car mat structure according to claim 3, wherein inclined cover pads being further formed and each covers the junction area between any of the two opposite dams with the bottom pad.

9. The car mat structure according to claim 1, wherein the angle between the first inclined surface and a vertical line is greater than the angle between the second inclined surface and a vertical line.

10. The car mat structure according to claim 3, wherein the angle between the first inclined surface and a vertical line is greater than the angle between the second inclined surface and a vertical line.

11. The car mat structure according to claim 1, wherein each of the said two opposite dams is parallel to the front direction of the car.

12. The car mat structure according to claim 3, wherein each of the said two opposite dams is parallel to the front direction of the car.

13. The car mat structure according to claim 1, wherein the angle between two adjacent dams is 90 degrees±5 degrees.

14. The car mat structure according to claim 2, wherein the angle between two adjacent dams is 90 degrees±5 degrees.

15. The car mat structure according to claim 3, wherein the angle between two adjacent dams is 90 degrees±5 degrees.

16. The car mat structure according to claim 1, wherein the upper part of each of the said two opposite dams being an inverted V shape.

17. The car mat structure according to claim 3, wherein the upper part of each of the said two opposite dams being an inverted V shape.
